(19) United States
(12) Patent Application Publication
(10) Pub. No.: US 2011/0170914 A1
(43) Pub. Date: Jul. 14, 2011

(54) MAGNETIC ARRANGEMENT IN A DEVELOPMENT ROLLER OF AN ELECTROSTATOGRAPHIC PRINTER

(76) Inventors: Dennis J. Grabb, Sodus, NY (US); Kenneth J. Brown, Penfield, NY (US); Robert E. Zeman, Webster, NY (US)

(21) Appl. No.: 12/687,155

(22) Filed: Jan. 14, 2010

(51) Int. Cl. G03G 15/09

(52) U.S. Cl. 399/267; 399/277

(57) ABSTRACT

An apparatus and method for arranging the spacing of magnets in an electrostatogaphic printer to eliminate steaks due to the magnetic carrier that does not move uniformly across the photoconductor surface.

### CROSS REFERENCE TO RELATED APPLICATIONS

This application has related subject matter to U.S. patent application Ser. No. 12/533,044, filed on Jul. 31, 2009

### FIELD OF THE INVENTION

The invention relates to electrographic printers and apparatus thereof. More specifically, the invention is directed to an apparatus and method for arranging the spacing of magnets in an electrostatographic printer.

### BACKGROUND OF THE INVENTION

Electrographic printers and copiers utilizing developer comprising toner, carrier, and other components use a developer mixing apparatus and related processes for mixing the developer and toner used during the printing process. The term “electrographic printer” is intended to encompass electrophotographic printers and copiers that employ dry toner developed on an electrophotographic photoconductor element, as well as ionographic printers and copiers that do not rely upon an electrophotographic photoconductor. The electrographic apparatus often incorporates an electromagnetic brush station or similar development station, to develop the toner to a substrate (an imaging/photoconductive member bearing a latent image), after which the applied toner is transferred onto a sheet and fused thereon.

A toner image may be formed on a photoconductor by the sequential steps of uniformly charging the photoconductor surface in a charging station using a corona charger or equivalent means, exposing the charged photoconductor to a pattern of light in an exposure station to form a latent electrostatic image, and toning the latent electrostatic image in a developer station to form a toner image on the photoconductor surface. The toner image may then be transferred in a transfer station directly to a receiver, e.g., a paper sheet, or it may first be transferred to an intermediate transfer member (ITM) and subsequently transferred to the receiver. The toned receiver is then moved to a fusing station where the toner image is fused to the receiver by heat and/or pressure.

In electrostatographic copiers and printers, pigmented thermoplastic particles, commonly known as “toner,” are applied to latent electrostatic images to render such images visible. Often, the toner particles are mixed with and carried by somewhat larger particles of magnetic material, the resulting mix referred to as a two-component developer. During the mixing process, the magnetic carrier particles serve to triboelectrically charge the toner particles to a polarity opposite that of the carrier. In use, the development mix is advanced, typically by magnetic forces, from a sump to a position in which it contacts the latent charge image.

The relatively strong electrostatic forces associated with the latent charge image operate to strip the toner from the carrier, causing the toner to remain with the charged image. Thus, it will be appreciated that, as multiple charge images are developed in this manner, toner particles are continuously depleted from the mix and a fresh supply of toner must be dispensed from time-to-time in order to maintain a desired image density. Usually, the fresh toner is supplied from a toner supply bottle mounted upside-down, i.e., with its mouth facing downward, at one end of the image-development apparatus. Under the force of gravity, toner accumulates at the bottle mouth, and a metering device, positioned adjacent the bottle mouth, operates to meter sufficient toner to the developer mix to compensate for the toner lost as a result of image development. Usually, the toner-metering device operates under the control of a toner concentration monitor that continuously senses the ratio of toner to carrier particles in the development mix.

Development stations require replenishment of toner into the developer sump to replace toner that is deposited on the photoconductor or receiver. The toner and carrier must be mixed and transported to a position where the developer can be in contact with the latent charged image. If the magnetic carrier and toner are not uniformly distributed across the surface of the photoconductor, the printing process is compromised.

The present invention corrects the problems of non-uniform magnetic carrier transport from the development station to the photoconductor surface as well as any other factors that contribute to non-uniform distribution of toner on the photoconductor that leads to streaking during printing. The apparatus and related methods described allow the printer to reduce or eliminate streaking associated with the prior art, in order to produce the high quality prints required by consumer demand, by utilizing the magnets more effectively to achieve more uniform toning.

### SUMMARY OF THE INVENTION

The invention is in the field of printing for electrographic printers. More specifically, the invention is directed to an apparatus and method for arranging the orientation of magnets in an electrostatographic printer

### BRIEF DESCRIPTION OF THE DRAWINGS

FIG. 1 is a side elevational view, in cross-section, of a reproduction apparatus magnetic brush developer station according to this invention.

FIG. 2 is an end view, partly in cross-section and on an enlarged scale, of the development roller of the magnetic brush development station of FIG. 1.

FIG. 3 is a view, in perspective, of the bar magnets of FIG. 1.

FIG. 4 is a view, in perspective, of the bar magnets arranged in a helical configuration.

### DETAILED DESCRIPTION OF THE INVENTION

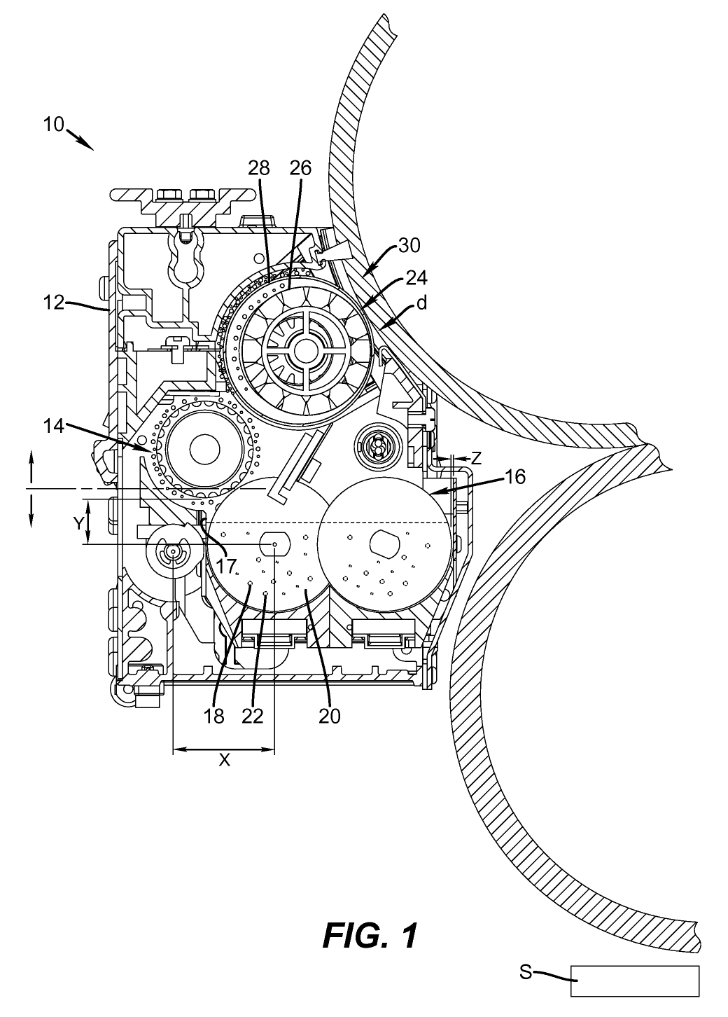

FIG. 1 shows an electrostatic printer magnetic brush developer station, according to this invention, sometimes simply referred to as a developer station, designated generally by the numeral 10. The development station housing 12 encloses a feed apparatus 14 and a powder conveyance device 16 and forms, in part, a reservoir of developer material 18 comprising a powder 20 and a magnetic carrier material 22, hereafter referred to as magnetic carrier 22. The magnetic carrier is described as a powder and could include one or more of magnetic carrier and magnetized toner including pigments (two component developers) as well as any other materials that are influenced by an electric and/or magnetic field.

The development roller 24, also referred to as a toning roller 24, is mounted within the development station housing 12. The development roller 24, which includes a core magnet 26, is shown in FIG. 1 as a fourteen-pole core magnet rotating counterclockwise inside a rotating shell 28. The development roller delivers a required quantity of developer material; including the powder 20 and the magnetic carrier 22, from the reservoir to the development zone (area neighboring 24 between the development roller 24 and the photoconductor 30). In prior art these magnets are arranged in a fixed manner so that all the magnets are uniformly arranged around the circumference of the developer roller perpendicular to the process direction. In the invention described below, the arrangement and spacing of the magnets is varied according to the specific needs of the printer for that paper and/or developer as well as other relevant process and environmental conditions that influence printing quality, including streaking on the prints. The core magnet 26 and the shell 28 can have many other suitable relative rotations as is known in the art.

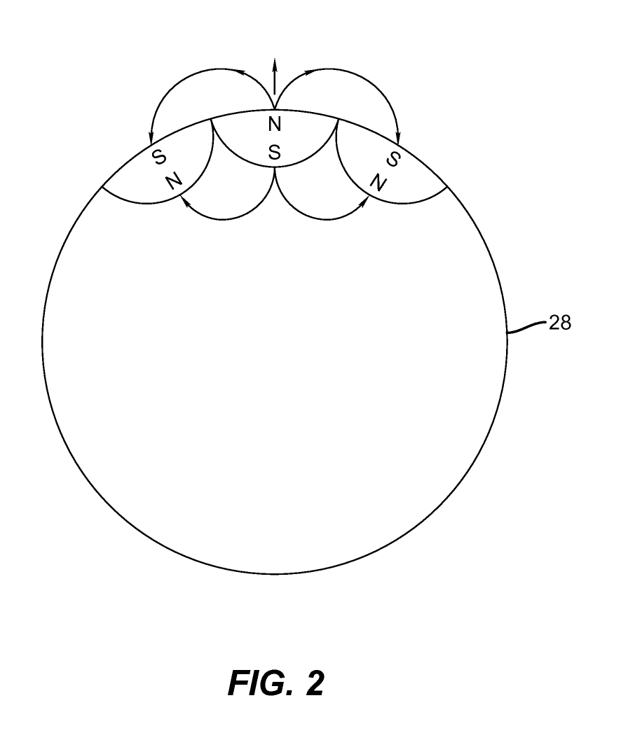

FIG. 2 shows a part of the development station 24 that employs a hard magnetic carrier, also known as a developer that uses a ferrite or other material that is resistant to demagnetization. In other embodiments a soft magnetic carrier could be used. The development station transports the developer through the action of magnets, such as rotating magnets. As shown in FIG. 2, rotating magnets cause the magnetic pole flips which in turn causes carrier chains to form and flip, thus moving the developer around the circumference in an “in track” direction in relation to the development roller 28. This results in no appreciable transverse (cross track) flow of developer on the roller surface 36, parallel to the roller axis 34. High speed video observations and laser measurements of developer thickness uniformity down the length of the development roller show that any thickness non-uniformities, whether due to uneven developer-feed-roller application or due to the propensity of hard magnetic carrier materials to clump unevenly, persist during the development process, thereby engendering uneven toning on the latent image. The measurement of developer is an average bulk velocity which is discussed in U.S. Ser. No. 12/533,044, filed Jul. 31, 2009, which is hereby incorporated by reference. An uneven developer mass density (on the development roller) produces optical density streaks on the printed image, which are unacceptable. Since uneven clumping of the developer is especially characteristic of hard ferrite magnetics, this enhances the problems.

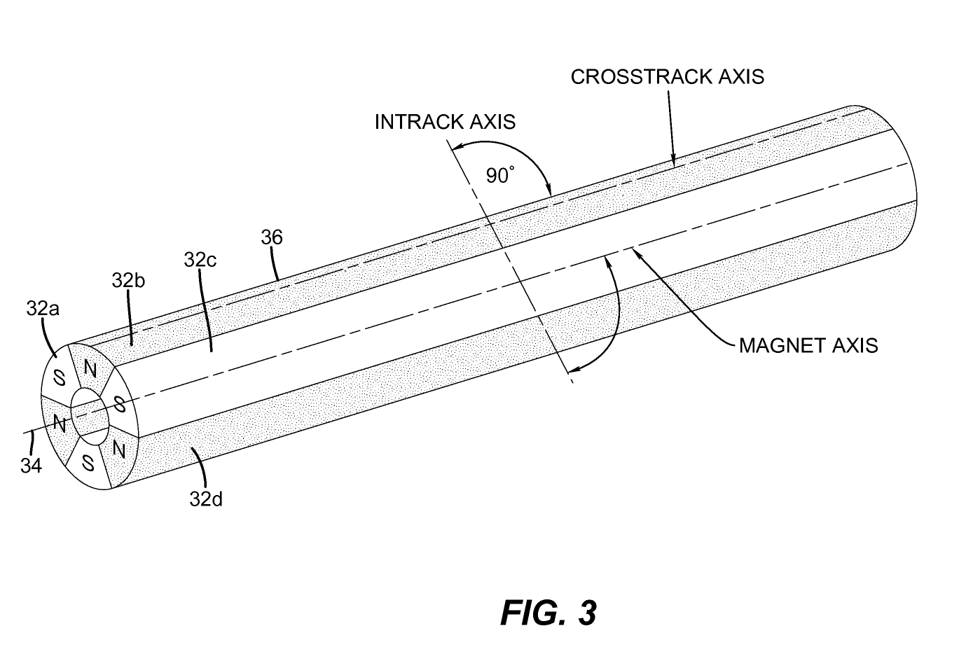

This invention creates transverse motion of the developer to time-average the uneven mass density over the development zone, which extends a short distance, in one case about 0.375″ in the in-track (process) direction and by making the effective lateral transport of the developer occur in a short enough time period, this time averages the mass density. The current embodiment shown in FIG. 3 has bar magnets 32 that are arranged parallel to the development roller axis 34. This arrangement produces developer flow around the surface of the roller 36 perpendicular to the roller axis 34. The lack of transverse developer motion on the development roller allows a non-uniform, circumferential mass density to perpetuate in place, producing optical density streaks in the toned image, when using this current magnet configuration.

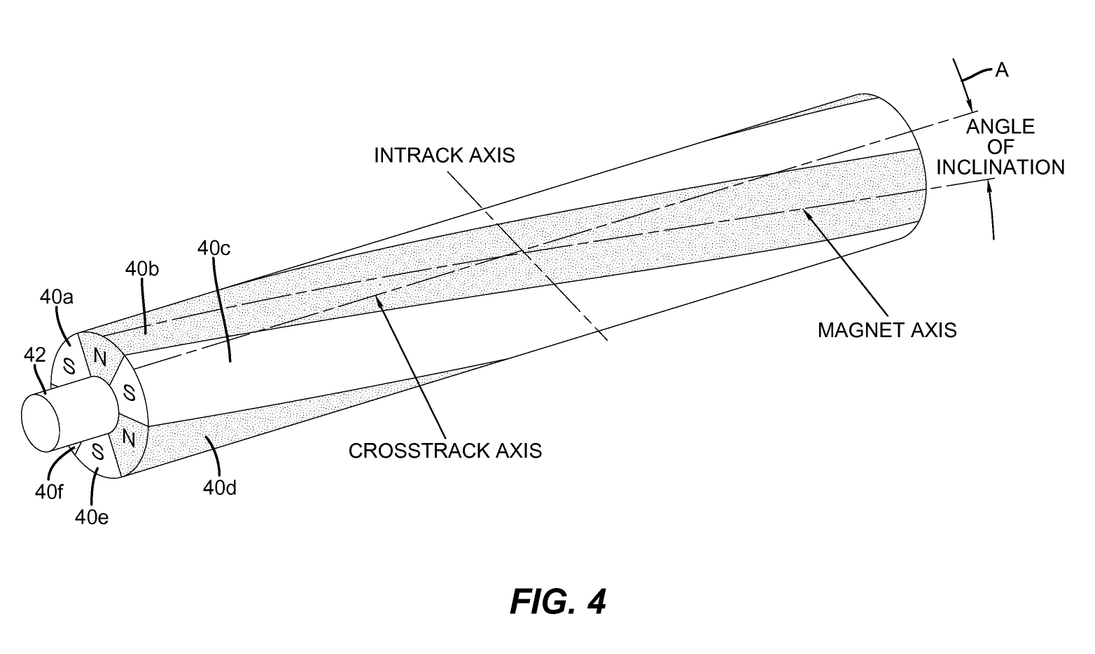

FIG. 4 shows one embodiment of this invention including a development roller 24 with a shell 28 containing two or more rotating magnets arranged to minimize the streaking. These magnets can rotate either separately from the shell or in synch with the shell. The developer can include hard or soft carrier particles. It can be part of a single or dual component system. In this embodiment the magnets 40 a-f are arranged in a helical manner within the shell 28 to receive developer from a developer reservoir. A controller for controlling the rotation speed of the two or more rotating magnets in relation to the photoconductor speed such that the powder is moved to the photoconductor as needed, and more specifically, in a manner that includes a cross track direction, is provided. Those skilled the art understand that these could be two or more magnets as required for effective transport of the powder.

The magnets 40a-f are wrapped around a developer roller core 42 in a predefined arrangement, such as the predefined helix angle of inclination A shown in FIG. 4 in order to promote developer flow in both in the “In-Track” and “Cross-Track” direction as required to give the uniformity desired. The amount of “Cross-Track” developer displacement is proportional to the helix angle A. This geometry creates the movement of developer in the cross track as well as the in track direction as needed for uniformity. Actual measurements have confirmed these results. The measurements come from affixing magnets at various helix angles and observing the movement of the developer in the cross track direction as well as the in track direction. The cross track movement of developer was increased or decreased by changing the angle and rotational speed of the magnets.

FIG. 4 shows 6 magnets but more or less could be used based on the priority requirement, including the print speed. The angle of inclination A of the helix in this embodiments between the magnets in FIG. 4 is about 20 degrees but could be varied from 10-55 degrees as needed. The quality of the images formed on the image-forming element depends on the number and spacing of these magnets. The number, strength and rotational speed of the magnets can be variable and depend on the particular imaging application.

The invention has been described in detail with particular reference to certain preferred embodiments thereof, but it will be understood that variations and modifications can be effected within the spirit and scope of the invention.

What is claimed is:

1. An electrophotographic printer for printing comprising:
a. a developer station comprising a development station housing, for transporting powder containing at least toner and magnetic carrier; and
a development roller comprising a shell containing two or more magnets arranged in a preset arrangement, in relation to the process direction, in the shell; and
b. a controller for controlling the two or more magnets such that the relative speed of the magnets is controlled to maximize developer uniformity.

2. The apparatus of claim 1, wherein said magnets rotate within said shell.

3. The apparatus of claim 1, wherein said magnets are arranged in a helical manner wherein said magnets are rotated separately from shell.

4. The apparatus of claim 1, wherein said magnets are arranged in a helical manner within said shell.

5. The apparatus of claim 4, wherein the angle of helix inclination A of the helix is between 15 degrees and 55 degrees.

6. The apparatus of claim 5, wherein the angle of helix inclination A of the helix is between 15 degrees and 25 degrees.

7. The apparatus of claim 1, wherein the two or more rotating magnets are arranged to move the volume of powder and magnetic carrier moved both axially and radially relatively to the photoconductor.

8. The apparatus of claim 7, wherein the movement axially and radially form a controlled ratio to optimize developer uniformity.

9. The apparatus of claim 8, wherein the controlled ratio is controlled by the speed of the magnets, the angle of inclination of the magnets and the speed of a rotational shell.

10. The apparatus of claim 1, wherein the two or more rotating magnets are placed such that they urge the toner to preferentially move in both a cross track and intrack direction.

11. The apparatus of claim 1, the controller further controlling the volume of toner moved to the development roller.

12. The apparatus of claim 1, the controller further controlling a speed of the rotation of the magnets in the development roller to further control the volume of toner that moves to the photoconductor.

13. The apparatus of claim 1 further comprising:
a reservoir that contains developer;
a feed roller including feed roller magnets that attract a magnetic carrier component of the developer from the reservoir,
a rotating shell that applies developer having an average developer bulk velocity.

14. The apparatus of claim 1, wherein the controller rotates the toning shell to move developer through the development area with an average developer bulk velocity substantially the same as the image member velocity.

15. The apparatus of claim 1 further comprises machine controller to control the toning shell such that a toning shell surface speed is greater than a photoconductor surface speed in the development area.

16. An electrographic printing apparatus, comprising:
an imaging member;
a development station comprising a development station housing located adjacent the imaging member and defining an image development area therebetween through which developer is passed for transporting powder containing at least toner and magnetic carrier,
a development roller comprising a shell containing two or more magnets arranged in a preset arrangement, in relation to the process direction, in the shell; and
a toning shell driver that moves the toning shell co-directionally with the imaging member.

17. The apparatus of claim 16, further comprising a magnetic field driver that drives one or more magnetic core poles to produce a magnetic field rotating in an opposite sense to the rotational direction of the toning shell.

18. A method for forming an electrographic image, comprising:
generating an electrostatic image on an imaging member;
moving the imaging member in a process direction through an image development area defined between a toning shell and the imaging member;
rotating a development roller having a shell containing two or more magnets arranged in a helix adjacent to the imaging member; and
applying developer in a controlled manner to maximize developer uniformity.

19. The method of claim 18, wherein the apply step is controlled by the speed of the magnets, the angle of inclination of the magnets and the speed of a rotational shell.

20. The method of claim 18, further comprising a magnetic field driver that drives one or more magnetic core poles to produce a magnetic field rotating in an opposite sense to the rotational direction of the toning shell.
